(19) United States
(12) Patent Application Publication
(10) Pub. No.: US 2007/0168984 A1
(43) Pub. Date: Jul. 19, 2007

(54) COMPILING SYSTEM, DEBUGGING SYSTEM AND PROGRAM DEVELOPMENT SYSTEM

(75) Inventors: Taketo HEISHI, Osaka (JP); Ryoko MIYACHI, Osaka (JP); Shohei MICHIMOTO, Osaka (JP); Teruo KAWABATA, Osaka (JP); Yasuhiro YAMAMOTO, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/555,449

(22) Filed: Nov. 1, 2006

(30) Foreign Application Priority Data
Nov. 22, 2005 (JP) 2005/337648

(51) Int. Cl. G06F 9/44; G06F 9/45

(52) U.S. Cl. 717/124; 717/140

(57) ABSTRACT

A compiling system which translates a source program written in a high-level language into a machine language program, and includes a source level optimizer which converts an original source S program into an optimized source program by optimizing the original source program at the source program level, a compiler which converts the optimized source program into the machine language program, and a final debug information selection generation unit which generates final debug information which indicates a corresponding relationship between the original source program and the machine language program.

### BACKGROUND OF THE INVENTION

(1) Field of the Invention

The present invention relates to a compiling system for translating a source program written in a high-level language such as C language into a machine language program, a debugging system for verifying the machine language program, and a program development system including the compiling system and the debugging system.

(2) Description of the Related Art

Conventionally, a system which includes a compiling system and a debugging system has been proposed as a program development system for a machine language program to be executed on a computer. The compiling system is a system realized by executing, on a computer, a program which converts a source program written in a high-level language such as C language into a machine language instruction sequence. The debugging system is a system realized by executing, on a computer, a program which receives a machine language program as an input and verifies the validity of the machine language program through operation control, data reference, and the like performed when the machine language program is being executed.

In such a program development system, the compiling system generates debug information which indicates, for example, a corresponding relationship between line numbers of the source program and a machine language instruction, or a corresponding relationship between symbol names in the source program and machine language data. In other words, the debug information indicates a corresponding relationship between the source program and the machine language program. In addition, the debugging system realizes a mechanism that allows a user to designate the information at the source level by reading and utilizing the debug information and to perform debugging.

On the other hand, these days, various source program conversion/optimization methods for converting a source program once into another source program have been proposed as a response to demands for an optimization mechanisms at the intermediate code level, secured confidentiality and the like (for example, see Japanese Patent Publication No. 6-80490 and Japanese Laid-Open Patent Application No. 2003-280754).

A source program generated by the source program conversion/optimization method is inputted to the compiling system which is similar to the conventional system and is converted into a machine language program by the compiling system.

In the case where the source program conversion/optimization method is utilized, with the conventional program development system, the debug information is generated in the compiling system based on the source program which has been converted at the source level. Therefore, the user cannot perform debugging on the source program which is originally written by him/herself, at the source level. This is because the utilization of the source program conversion/optimization method causes shifts in line numbers of the source program, modifications in control mechanisms or in function names and variable names.

Accordingly, it is necessary for the user to perform debugging based on the source program generated automatically by the source program conversion/optimization method, or to perform debugging directly (at a machine language instruction level) on the generated machine language program. Consequently, debugging efficiency of the source program performed by the user is decreased.

Therefore, there is a problem that the user of system software needs to find data alignment and the like after much trial and error so that a large number of efforts are required for the system software development.

### SUMMARY OF THE INVENTION

The present invention is conceived to solve the aforementioned problem and has an object to provide a compiling system, a debugging system and a program development system, which can maintain ease in debugging on software even when conversion/optimization is performed at the source level, and increase convenience and development efficiency of the software development.

In order to solve the aforementioned object, a compiling system according one aspect of the present invention is a compiling system for translating a source program into a machine language program, the system includes: a source program conversion unit which converts a first source program written in a high-level language into a second source program written in the high-level language, by optimizing the first source program at the source program level; a compiling unit which converts the second source program into a machine language program; and a debug information generation unit which generates first debug information which indicates a corresponding relationship between the first source program and the machine language program, by referring to a corresponding relationship between the first source program and the second source program and a corresponding relationship between the second source program and the machine language program.

With this configuration, at the time of debugging, debugging based on the first source program can be performed by utilizing the first debug information. Therefore, it is possible to provide a compiling system which can maintain ease in debugging even when conversion/optimization is performed at the source level, and increase convenience and development efficiency of the software development.

It is preferred that the compiling system further includes: a preprocessing unit which analyzes a directive included in the second source program and executes preprocessing on the second source program based on the result of the analysis; and a directive deletion unit which deletes, from the second source program, a line including the directive which is analyzed by the preprocessing unit and is added by the source program conversion unit.

With this configuration, a line added at the time of conversion from the first source program into the second source program is deleted from the second source program. Consequently, the misalignment of line numbers between the first source program and the second source program caused by the addition of lines is resolved, and the corresponding relationship between the line numbers of the first source program and the line numbers of the second source program can be maintained. Therefore, it is possible to maintain ease in debugging even when conversion/optimization is performed at the source level, and increase convenience and development efficiency of the software development.

More preferably, the source program conversion unit includes a line number retaining conversion unit which converts the first source program into the second source program, while retaining a corresponding relationship between line numbers of the first source program and line numbers of the second source program. The source program conversion unit further includes a source conversion debug information generation unit which generates source conversion debug information which collects modifications caused by the source program conversion performed by the line number retaining conversion unit. In addition, the source conversion debug information includes a statement which corresponds to a portion to be converted in the first source program and a statement which corresponds to a portion in the second source program in which the portion to be converted has been converted.

With this configuration, the user can perform debugging based on the first source program by utilizing the source conversion debug information at the time of debugging. Therefore, it is possible to maintain ease in debugging even when conversion/optimization is performed at the source level, and increase convenience and development efficiency of the software development.

The debugging system according to one of other aspects of the present invention is a debugging system for supporting debugging of a machine language program, the debugging system includes; a program execution unit which executes a machine language program which is obtained by compiling a second source program written in a high-level language, the second source program being obtained by optimizing a first source program written in the high-level language; and a debug support unit which receives first debug information which indicates a corresponding relationship between the first source program and the machine language program and second debug information which indicates a corresponding relationship between the second source program and the machine language program, by referring to a corresponding relationship between the first source program and the second source program and the corresponding relationship between the second source program and the machine language program, and supports debugging of the machine language program by a user based on the first debug information, the second debug information, and the result of the execution obtained by the program execution unit.

With this configuration, the user can perform debugging on the first source program based on the first debug information. It is therefore possible to provide a compiling system which can maintain ease in debugging even when conversion/optimization is performed at the source level, and increase convenience and development efficiency of the software development.

It is preferred that the debugging system further includes: a conversion portion display control unit which displays a statement which corresponds to a portion to be converted in the first source program and a statement which corresponds to a portion in the second source program in which the portion to be converted has been optimized; a selection receiving unit which receives a selection of one of the statement which corresponds to the portion to be converted and the statement which corresponds to the post-conversion portion; and a profile information generation unit which generates, as profile information, information received by the selection receiving unit, In addition, the profile information generation unit adds the number of execution cycles when the statement which corresponds to the portion to be converted or the statement which corresponds to the post-conversion portion is executed by the program execution unit.

With this configurations, the compiling system allows selecting one of a portion to be converted and the post-conversion portion with smaller execution cycles and to perform compiling. Therefore, a machine language program with small number of execution cycles can be created.

The program development system according to another one of other aspects of the present invention is a program development system for developing a machine language program from a source program, and includes the aforementioned compiling system and debugging system. The debugging system further includes an execution log output unit which outputs an execution log at the time of executing the machine language program by the program execution unit. The program development system further includes a profiling unit which analyzes the execution log outputted from the debugging system, and outputs profile information which gives a hint on optimization in the compiling system, and the source program conversion unit of the compiling system optimizes the first source program based on the profile information.

With this configuration, the compiling system is connected with the debugging system via the profiling unit so that a machine language program can be gradually updated while automatically activating these systems again and again. Therefore, the optimization of the machine language program can be automated so that an optimal machine language program is automatically selected and determined while restraining manpower required for the user to perform tuning on the machine language program at minimum. Therefore, it is possible to provide a compiling system which can maintain ease in debugging even when conversion/optimization is performed at the source level, and increase convenience and development efficiency of the software development.

It should be noted that the present invention is not realized as a compiling system, a debugging system and a program development system, which include above-identified characteristic units, but also as a compiling method, a debugging support method, and a program development program, which have, as steps, the characteristic units included in the compiling system, debugging system and program development system, and as a program for causing a computer to execute the characteristic steps included in the compiling method, debugging support method and program development method. In addition, it is obvious that such program can be distributed via a recording medium such as Compact Disc-Read Only Memory (CD-ROM) and a communication network such as the Internet. According to the present invention, it is possible to provide a compiling system, a debugging system, and a program development system, which can maintain ease in debugging even when conversion/optimization is performed at the source level, and increase convenience and development efficiency of the software development.

As further information about technical background to this application, the disclosure of Japanese Patent Application No. 2005-337648 filed on Nov. 22, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a block diagram showing a configuration of a program development system according to the embodiment of the present invention;

FIG. 2 is a block diagram showing a configuration of a compiling system according to the embodiment of the present invention;

FIG. 3A to FIG. 3C are diagrams showing an example of program conversion performed by a line number retaining conversion unit;

FIG. 4A to FIG. 4C are diagram showing one of other examples of program conversion performed by the line number retaining conversion unit;

FIG. 5A and FIG. 5B are diagrams showing one of other examples of program conversion performed by the line number retaining conversion unit;

FIG. 6A and FIG. 6B are diagrams showing one of other examples of program conversion performed by the line number retaining conversion unit;

FIG. 7A and FIG. 7B are schematic diagrams showing an example of line number table information;

FIG. 8 is a diagram showing an example of symbol table information;

FIG. 9 is a diagram showing an example of source conversion debug information outputted by the source conversion debug information generation output unit;

FIG. 10 is a diagram showing a preprocessor directive which can be analyzed by a line adjustment unit;

FIG. 11 is a flowchart showing processes executed by the line adjustment unit;

FIG. 12 is a flowchart showing processes executed by a line number adjustment unit;

FIG. 13 is a block diagram showing a configuration of a debugging system according to the embodiment of the present invention;

FIG. 14 is a diagram showing an example of source conversion information displayed by a source conversion information display unit;

FIG. 15 is a diagram showing a display screen on which the result of debugging obtained by the debug processing unit is displayed;

FIG. 16 is a diagram showing an example of profile information outputted by a profiler;

FIG. 17 is a flowchart showing processing details performed by a profile information utilization optimization unit;

FIG. 18 is a diagram showing an example of line number table information representing only a group of modified lines;

FIG. 19 is a diagram showing an example of symbol table information which adopts a table structure indicating one-to-one corresponding relationship; and

FIG. 20 and FIG. 21 are block diagrams, each showing one of other configurations of the program development system according to the embodiment of the present invention.

### DESCRIPTION OF THE PREFERRED EMBODIMENT

Hereinafter, a program development system according to the embodiment of the present invention shall be described with reference to the drawings.

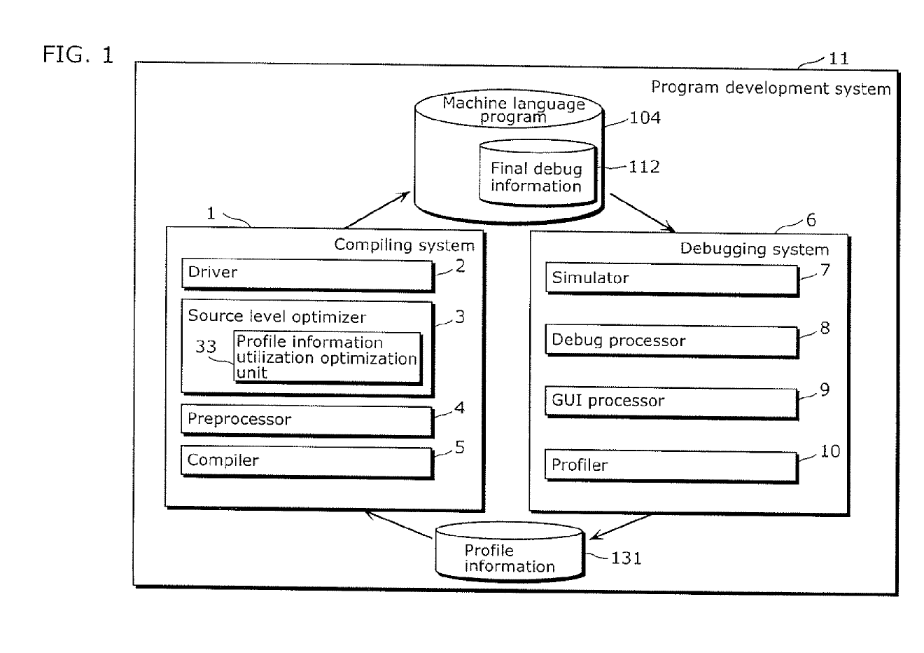

FIG. 1 is a block diagram showing a configuration of the program development system according to the embodiment of the present invention.

The program development system 11 is a system which generates a machine language program 104 from an inputted source program (not shown in the diagram) written in a high-level language such as C language, and includes a compiling system 1 and a debugging system 6.

The compiling system 1 is a system which reads a source program and profile information 131 and converts the source program into a machine language program 104. The detailed configuration of the compiling system 1 shall be described later.

The debugging system 6 reads the machine language program 104 generated in the compiling system 1, performs simulation and information display with respect to the machine language program 104, and supports analysis/debugging to be performed on the machine language program 104 and the source program. The debugging system 6 outputs profile information 131 which is information to be a hint on optimization in the compilling system 1 by executing the machine language program 104. The details of the debugging system 6 shall be described later

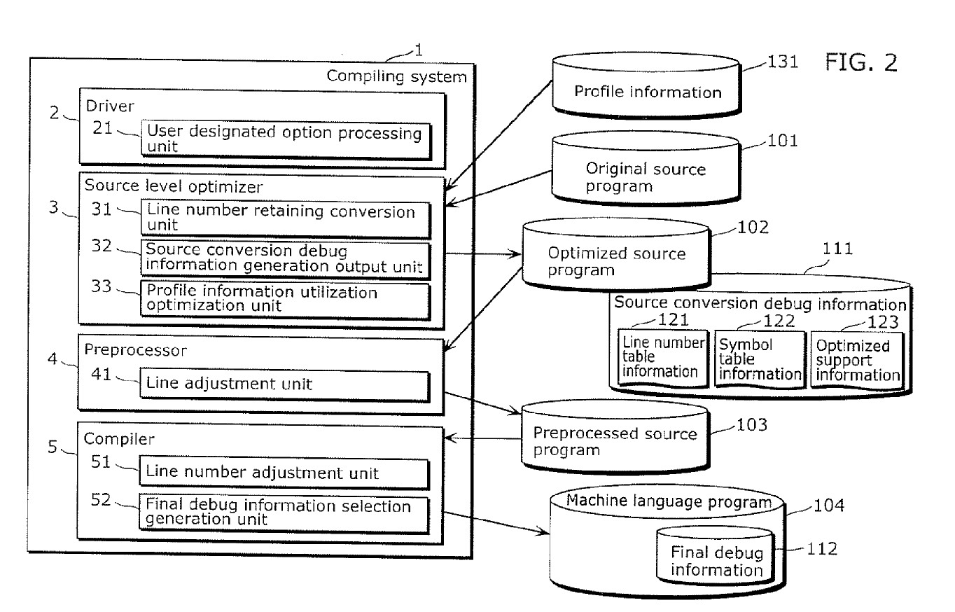

FIG. 2 is a block diagram showing a configuration of the compiling system 1 which is a constituent element of the program development system according to the present invention.

The compiling system 1 includes a driver 2, a source level optimizer 3, a preprocessor 4, and a compiler 5. Each constituent element of the compiling system 1 is realized as a program to be executed on a computer (not shown in the diagram).

The source level optimizer 3, the preprocessor 4 and the compiler 5 are respectively an example of a source program conversion unit, a preprocessing unit and a compiling unit disclosed in the scope of claims.

The driver 2 has a function of activating, as an appropriate option, the source level optimizer 3, the preprocessor 4 and the compiler 5, which are other constituent elements of the compiling system 1, as necessary according to a compile option designated by the user.

The source level optimizer 3 receives, as an input, the profile information 131 and the original source program 101 written by the user, optimizes the received program at the source level, and outputs, an optimized source program 102 which is an optimized source program. The optimization performed herein includes: parallel processing such as vectorization and multi-thread processing; profile information utilization optimization; and inter-file optimization. The source level optimizer 3 can also receive the profile information 131 as an input, and in the case where the profile information 131 is inputted, perform optimization and conversion utilizing the inputted profile information 131.

The preprocessor 4 receives the optimized source program 102 as an input, and analyzes a preprocessor directive such as “#define” included in the optimized source program 102 written in C language prior to compiling performed by the compiler 5. The preprocessor 4 performs pre-processing on the source program 102 based on the analysis result, and transmits the preprocessed source program 103, which is a source program on which preprocessing has been performed, to the compiler 5.

The compiler 5 converts the inputted preprocessed source program 103 into an internal intermediate expression written in an intermediate language, optimizes the expression, and generates the machine language program 104 for a target processor.

Hereinafter, it shall be described a detailed configuration and operation of each constituent element of the compiling system 1.

The driver 2 has a user designated option processing unit 21. The user designated option processing unit 21 transmits a user's option directive regarding final debug information 112 to be generated by the compiling system 1, to the compiler 5. Specifically, the user's option directive includes the following three directives:

(1) a directive which instructs generating debug information based on the original source program 101;

(2) a directive which instructs generating debug information based on the optimized source program 102;

(3) a directive which instructs generating both of debug information based on the original source program 101 and debug information based on the optimized source program 102.

In these three option directives, the directive (1) corresponds to “-orgsrcdbg” option, the directive (2) corresponds to “optsrcdbg” option, and the directive (3) corresponds to “-bothsrcdbg” option.

For example, it is assumed that a -file name of the original source program 101 is “test.c” and a command for activating the compiling system 1 is “cc”. In this case, in order to send the directive (1) to the compiling system 1, the user inputs a command of “cc -orgsrcdbg test.c” in a command line.

The source level optimizer 3 includes a line number retaining conversion unit 31, a source conversion debug information generation output unit 32, and a profile information utilization optimization unit 33.

The line number retaining conversion unit 31 and the source conversion debug information generation output unit 32 are respectively an example of a fine number retaining conversion unit and a source conversion debug information generation unit disclosed in the scope of claims.

The profile information utilization optimization unit 33 has a function of performing optimization in consideration of the input profile information 131. The operation of the profile information utilization optimization unit 33 shall be described later

The line number retaining conversion unit 31 has a function of converting the original source program 101 at the source level caused by optimizing the original source program 11, while retaining line numbers of respective statements in the original source program 101 so that the line numbers are not modified in the post-conversion optimized source program 102 in order to maintain ease for debugging.

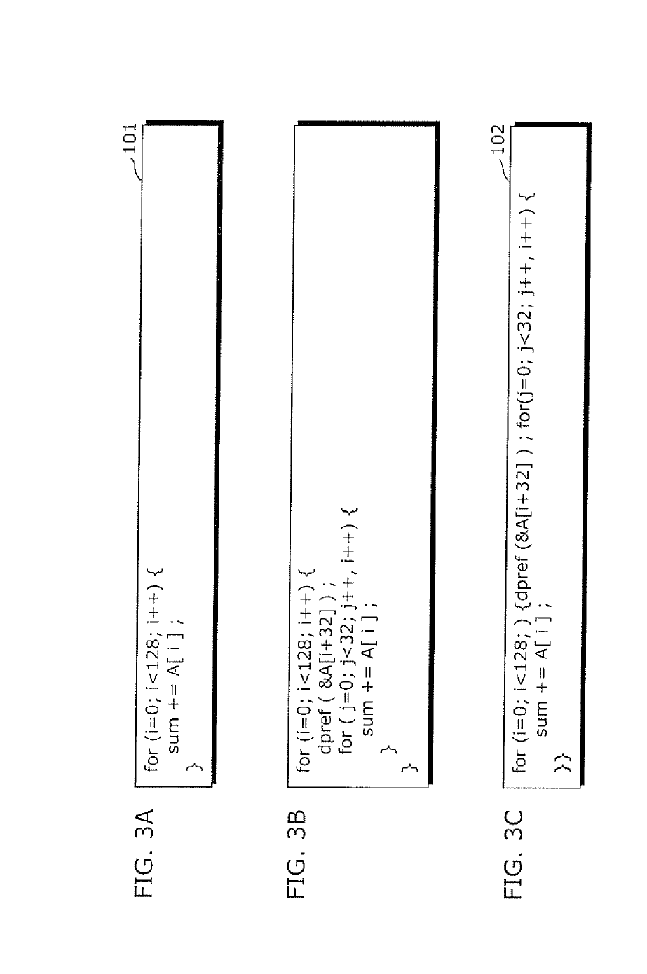

FIG. 3A to FIG. 3C are diagrams showing an example of program conversion performed by the line number retaining conversion unit 31.

The line number retaining conversion unit 31 divides a loop of the original source program 101 as shown in FIG. 3A into loops of respective lines of a cache memory as shown in FIG. 3B, and performs optimization so as to insert pre-fetch processing. After that, the line number retaining conversion unit 31 closes space between the lines of the newly generated statement as shown in FIG. 3C, converts the original source program 101 in FIG. 3A so as to retain line numbers of respective statements in the original source program, and generates the optimized source program 102. Specifically, the line number retaining conversion unit 31 converts the original source program 101 so that a line number of a substitute statement into a variable sum is the second line both in the original source program 101 and the optimized source program 102.

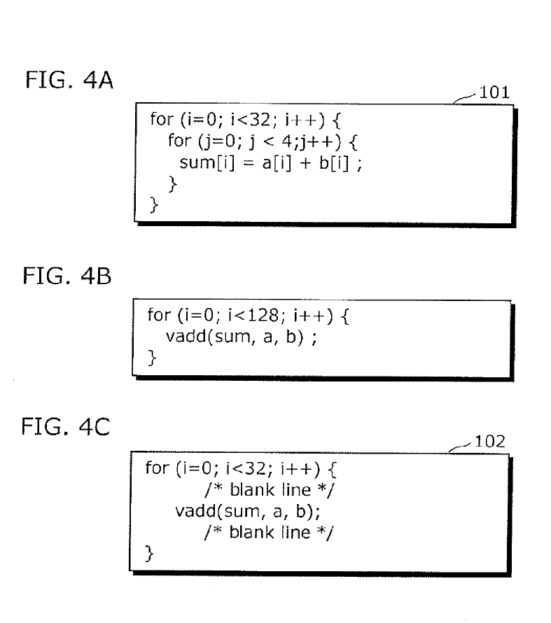

FIG. 4A to FIG. 4C are diagrams showing an example of another program conversion performed by the line number retaining conversion unit 31.

The line number retaining conversion unit 31 performs vectorization on the inner most loop processing as shown in FIG. 4B with respect to the original source program 101 as shown in FIG. 4A, and converts the original source program 101 so as to perform the innermost loop processing with the vector instruction vadd. After that, the line number retaining conversion unit 31 inserts blank lines for the lines deleted in the conversion processing as shown in FIG. 4C, converts the original source program 101 so as to retain line numbers of each statement in the original source program 101 shown in FIG. 4A, and generates an optimized source program 102.

Specifically, the line number retaining conversion unit 31 retains the line numbers to be the same in the original source program 101 and the optimized source program 102 by filling the second and fourth lines of the original source program 101 with blank lines.

The source conversion debug information generation output unit 32 has a function of outputting the line number table information 121 and the symbol table information 122 respectively as the source conversion debug information 111 in the case where the line numbers are modified between the original source program 101 and the optimized source program 102 or in the case where symbol names such as function names or variable names are changed due to the source level conversion of the original source program 101.

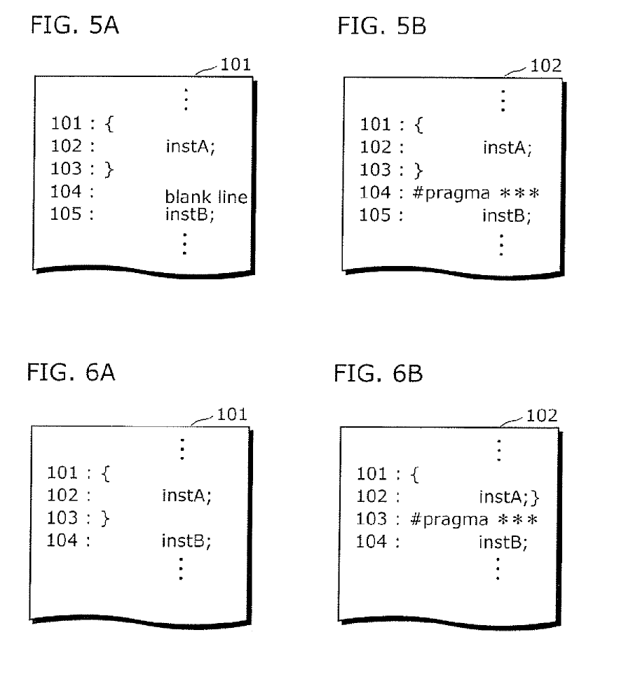

FIG. 5A and FIG. 5B are diagrams showing an example of another program conversion performed by the line number retaining conversion unit 31.

FIG. 5A shows the original source program 101 before being optimized by the source level optimizer 3. Here, the 104-th line is a blank line. After the optimization processing by the source level optimizer 3, in the case where the pragma directive “#pragma ***” is inserted immediately before the 105-th line, the pragma directive is inserted into the 104-th line which is a blank line, and the optimized source program 102 as shown in FIG. 5B is generated. With the aforementioned processing, the line numbers are retained to be the same in the original source program 101 and the optimized source program 102.

FIG. 6A and FIG. 6B are diagrams showing an example of another program conversion performed by the line number retaining conversion unit 31.

FIG. 6A shows an original source program 101 before being optimized by the source level optimizer 3. After the optimization processing by the source level optimizer 3, in the case where the pragma directive “#pragma ***” is inserted immediately before the 104-th line, the line number retaining conversion unit 31 moves the “}” in the 103-th line of the original source program 101 to the 102-th line, inserts the pragma directive “#pragma ***” into the 103-th line, and generates the optimized source program 102 as shown in FIG. 6B. Through aforementioned processing, the line numbers are retained to be the same in the original source program 101 and the optimized source program 102.

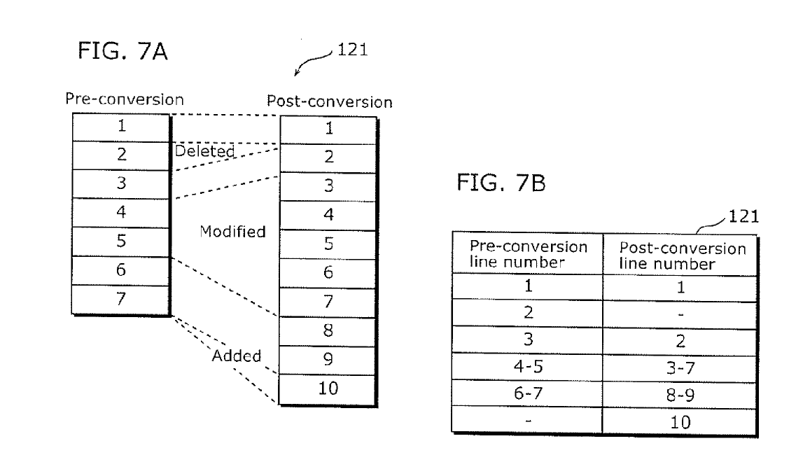

FIG. 7A and FIG. 7B are schematic diagrams showing an example of line number table information 121. FIG. 7A is a diagram showing an example of line number changes due to the source level conversion. Specifically, the line number table information 121 indicates that the original source program 101 in the seventh line, which is a pre-conversion program, and that the post-conversion optimized source program 102 is the program in the tenth line. Furthermore, it indicates that the second line of the original source program 101 is deleted due to the source level conversion, that the fourth and fifth lines of the original source program 101 are modified to the third to seventh lines in the optimized source program 102, and that the statement which does not exist in the original source program 101 is added to the tenth line of the optimized source program 102.

FIG. 7B shows the line number table information 121 which indicates details that are the same as the line number table information 121 shown in FIG. 7A. Here, the left column indicates line numbers of the original source program 101, and the right column indicates line numbers of the optimized source program 102. In the line number table information 121, the portion “-” indicates that there is no corresponding line, and the portion “3-7” corresponds to the third line to the seventh line indicating a range of source lines. For example, it is indicated that the fourth to fifth lines in the original source program 101 correspond to the third to seventh lines in the optimized source program 102.

Accordingly, the source conversion debug information generation output unit 32 collects, in a table, corresponding relationships of respective portions in which line numbers of a source program are modified before and after the source level conversion. However, with respect to the items in which line numbers are adjusted by under-mentioned preprocessor 4 and compiler 5, the line numbers are adjusted without using the source conversion debug information 111. Therefore, necessary information is generated herein considering the adjustment.

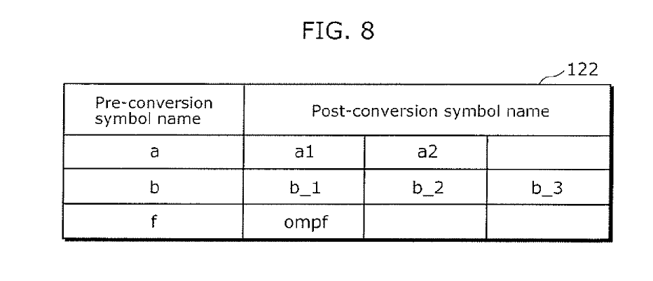

FIG. 8 is a diagram showing an example of the symbol table information 122. FIG. 8 is a diagram showing an example of the symbol table information 122. The source conversion debug information generation output unit 32 collects, in a table, corresponding relationship of respective symbols, with respect to the symbols whose variation name and function name are changed before and after the source level conversion, the symbols which are divided into plural functions and variables, and the symbols in which plural functions and variables are integrated, As shown in FIG. 8, there is a case where a pre-conversion symbol corresponds to plural converted symbols, depending on a symbol. In such case, all those symbols are kept in the table. In the symbol table information 122 shown in FIG. 8, the symbol name in the original source program 101 is indicated as a pre-conversion symbol name and the symbol name in the optimized source program 102 is indicated as a converted symbol name. For example, the symbol table information 122 indicates that the symbol name a in the original source program 101 is converted into the symbol names a1 and a2 in the optimized source program 102.

The source conversion debug information generation output unit 32 further generates, as source conversion debug information 111, optimization support information 123 for supporting optimization in the compiler 5. Specifically, the source conversion debug information generation output unit 32 generates a combination of each portion of a source program before and after the conversion by the source level optimizer 3 or a corresponding relationship of conversion candidates, and the number of execution cycles for each source program. With respect to the number of execution cycles, a value is set only in the case where the value is designated in the profile information 131, and otherwise “0” is set. Here, information regarding the converted portions of the converted source program is not necessarily restricted to one, so that the information regarding the source program and the number of execution cycles can be outputted for plural conversion candidate patterns.

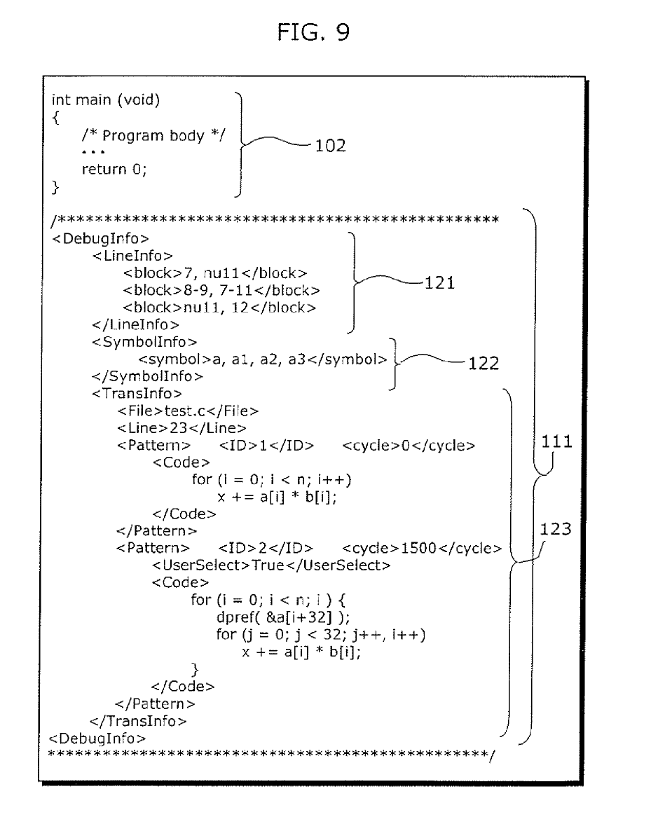

FIG. 9 is a diagram which shows an example of the source conversion debug information 111 outputted by the source conversion debug information generation output unit 32.

The source conversion debug information 111 is text information indicating the line number table information 121, the symbol table information 122 and the optimization support information 123, and is outputted as a comment attached at the end of the optimized source program 102 which is an output file.

That is to say, a portion of the “main” function corresponds to the optimized source program 102. Also, in the comment statement enclosed in the tags “/*” and “*/”, a portion between the tag <DebugInfo> and the tag </DebugInfo> corresponds to the source conversion debug information 111. The portion between the tag <LineInfo> and the tag </LineInfo> corresponds to the line number table information 121. The portion between the tag <SymbolInfo> and the tag </SymbolInfo> corresponds to the symbol table information 122. Furthermore, the portion between the tag <TransInfo> and </TransInfo> corresponds to the optimized support information 123.

The line number table information 121 is made up of three lines respectively enclosed in the tags <block> and </block>.

Here, the first line indicates that the seventh line of the original is source program 101 is deleted in the optimized source program 102. The second line indicates that the eighth to ninth lines of the original source program 101 are modified to the seventh to eleventh lines of the optimized source program 102. The third line indicates that a new line which does not exist in the original source program 101 is added to the twelfth line of the optimized source program 102.

The symbol table information 122 is made up of one line which is enclosed in the tags <symbol> and </symbol>, indicating that a symbol a in the original source program 101 corresponds to symbols a1, a2, and a3 in the optimized source program 102.

In the optimized support information 123, a character string “test.c” indicated in the portion between the tag <File>and the tag </File> shows a file name of the original source program 101 to be compiled. The value “23” indicated in the portion between the tag <Line>and the tag </Line>shows a head line number of the portion to be converted in the original source program 101. The portion between the tag <Pattern>and the tag </Pattern>indicates a conversion pattern after the conversion performed by the source level optimizer 3. Here, two types of conversion patterns are shown. An identifier is attached to each conversion pattern and is indicated in the portion enclosed in the tags <ID> and </ID>. Specifically, numbers “1” and “2” are attached as respective identifiers. Furthermore, each conversion pattern is indicated in the portion enclosed in the tags <Code>and </Code>. The number of cycles in which each conversion pattern is executed by being replaced to a machine language instruction is indicated in the portion enclosed in the tags <cycle> and </cycle>. Here, “0” is set as the number of cycles executing the conversion pattern with the identifier “1”. As described in the above, “0” indicates that the profile information 131 does not designate the number of execution cycles. On the other hand, “1500” is set as the number of cycles executing the conversion pattern with the identifier “2”. This indicates that the number of executing the conversion pattern with the identifier “2” is 1500 cycles. Furthermore, “<UserSelect>True</UserSelect>” indicates that the conversion pattern with the identifier “2” is selected by a user.

Next, it shall be described the preprocessor 4 shown in FIG. 2. The preprocessor 4 has a line number adjustment unit 41. The line adjustment unit 41 is an example of a directive deletion unit disclosed in the scope of claims.

In the conventional preprocessor processing, a preprocessor directive is analyzed and processing is performed based on the analysis. The preprocessor directive line is outputted as a blank line so that line numbers of respective statements of the original source program are kept to be the same. For example, when the conventional preprocessor receives a preprocessor directive of “#define AB”, replaces all A in the source program with B, and outputs, as a blank line, the line in which the preprocessor directive was indicated.

The line adjustment unit 41 of the preprocessor 4 according to the present invention inputs the optimized source program 102, recognizes a preprocessor directive such as “#pragma” inserted by the source level optimizer 3, performs processing corresponding to the directive, and then deletes the preprocessor directive inserted by the source level optimizer 3, Consequently, the misalignment of line numbers between the original source program 101 and the optimized source program 102 caused by the insertion of preprocessor directive performed by the source level optimizer 3, and therefore the corresponding relationship of line numbers between the original source program 101 and the preprocessed source program 103 is maintained regarding the target portion.

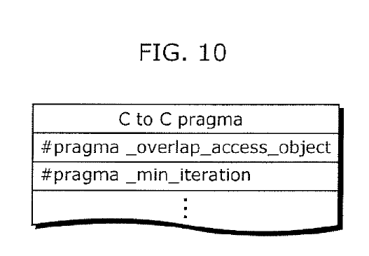

FIG. 10 is a diagram showing an example of a preprocessor directive which can be analyzed by the line adjustment unit 41. The line adjustment unit 41 holds, as a list, a pragma directive which is a type of a preprocessor directive as shown in this diagram, and performs above-mentioned processing on the preprocessor directive registered on this list.

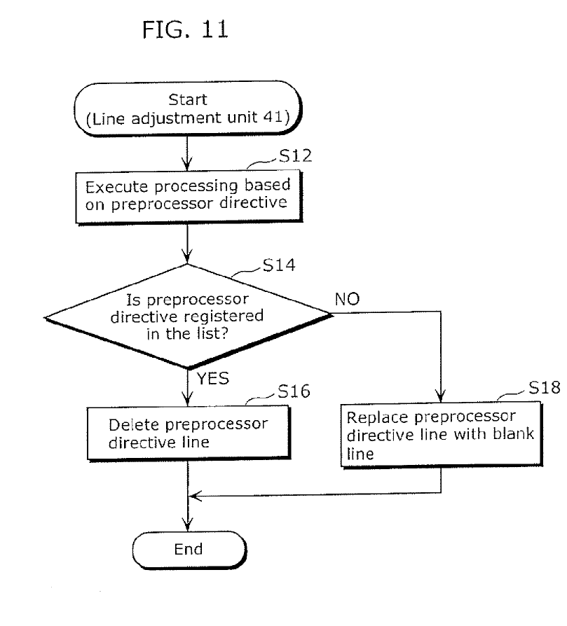

FIG. 11 is a flowchart showing a process executed by the line adjustment unit 41. The line adjustment unit 41 executes, based on a preprocessor directive included in the optimized source program 102, a process indicated by the directive in the current statement (S12). Next, the line adjustment unit 41 judges whether or not the processed preprocessor directive is registered on the list as shown in FIG. 10 (S14). In the case where the preprocessor directive is registered on the list (YES in S14), the line adjustment unit 41 deletes the line in which the preprocessor directive statement is written, from the optimized source program 102 (S16). In the case where the preprocessor directive is not registered on the list (NO in S14), the line adjustment unit 41 replaces the line in so which the preprocessor directive is written with a blank line (S18). Through the above-mentioned processing, the preprocessor 4 converts the optimized source program 102 into the pre-processed source program 103.

Next, it shall be described the compiler 5 shown in FIG. 2. The compiler 5 includes a line number adjustment unit 51 and a final debug information selection generation unit 52. The line number adjustment unit 51 is an example of a line number information generation unit disclosed in the scope of claims. The final debug information selection generation unit 52 is an example of the debug information generation unit and the debug information output unit disclosed in the scope of the claims.

The compiler 5 receives the preprocessed source program 103 as an input, analyzes each statement per line through lexical analysis and syntactic analysis usually by incrementing an internal line number counter, and associates each statement with a corresponding line number in order to generate line number information which is a part of the final debug information 112.

The line number adjustment unit 51 recognizes a compile directive such as “#pragma” inserted by the source level optimizer 3 in the preprocessed source program 103, and decrements the internal line number counter when a process based on the compile directive inserted by the source level optimizer 3 is performed after a processing corresponding to the directive is performed. The line number adjustment unit 51 thus generates line number information which ignores the compile directive inserted by the source level optimizer 3. Accordingly, the compiler 5 can internally deal with displacement of a line number between the original source program 101 and the preprocessed source program 103 caused by the insertion of the compile directive by the source level optimizer 3. With respect to the corresponding portion, the consistency in the corresponding relationship of statements and line numbers between the original source program 101 and inside the compiler 5 is secured.

Note that, the example of the compile directive which can be analyzed by the line number adjustment unit 51 is the same as the preprocessor directive which can be analyzed by the line adjustment unit 41 of the preprocessor 4. Specifically, the line number adjustment unit 51 holds a list which is similar to the list of the preprocessor directive which can be analyzed by the line adjustment unit 41 shown in FIG. 10.

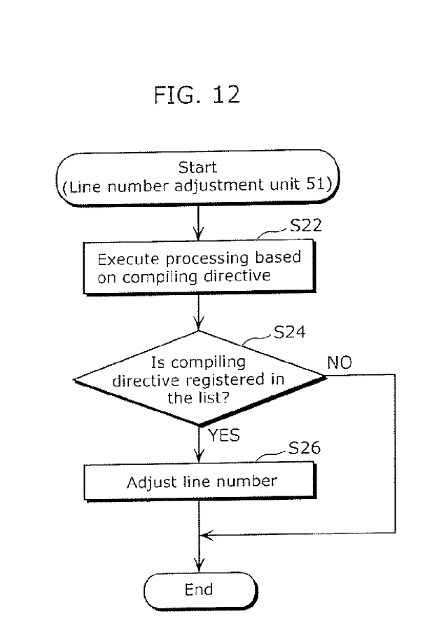

FIG. 12 is a flowchart showing a process executed by the line number adjustment unit 51. The line number adjustment unit 51 executes processing based on the compile directive included in the preprocessed source program 103 (S22). The line number adjustment unit 51 judges whether or not the compile directive is registered in the above-identified list (S24). In the case where the compile directive is registered in the list (YES in S24), the line number adjustment unit 51 adjusts line numbers by decrementing the internal line number counter as described in the above (S26). Specifically, adjustment processing so as to count the line numbers except the line directed to be compiled is performed.

The final debug information selection generation unit 52 outputs one of the following information as the final debug information 112 so as to be included in the machine language program 104, in accordance with the directive of the compile option transmitted by the driver 2 and designated by the user.

(1) Debug information based on the original source program 101

(2) Debug information based on the optimized source program 102

(3) Debug information including the debug information based on the original source program 101 and the debug information based or the optimized source program 102

In particular, in the case where debug information based on the original source program 101 is required (in the above-identified cases of (1) and (2)), the final debug information selection generation unit 52 generates necessary information (for example, a corresponding relationship of line and symbols between the machine language instruction and the source code) from the preprocessed source program 103 and the source conversion debug information 111. Specifically, the final debug information selection generation unit 52 generates line information of the original source program 101 based on the line number table information 121, generates symbol information of the original source program 101 based on the symbol table information 122, and outputs the symbol information so as to be included in the final debug information 112.

Furthermore, the final debug information selection generation unit 52 also outputs the optimized support information 123 so as to be included in the final debug information 112.

Because the compiling system 1 is configured as described in the above, even in the case where the source optimizer 3 is adopted, the debug information (final debug information 112) can be generated based on the original source program 101. Accordingly, the user can perform source level debugging based on the original source program 101. Furthermore, by combining plural processes such as a line number retaining conversion process performed by the source level optimizer 3, a line adjustment process and the like performed by the preprocessor 4 and the compiler 5, the amount of additional information such as the source conversion debug information 111 which is not used in the conventional compiling system can be minimized.

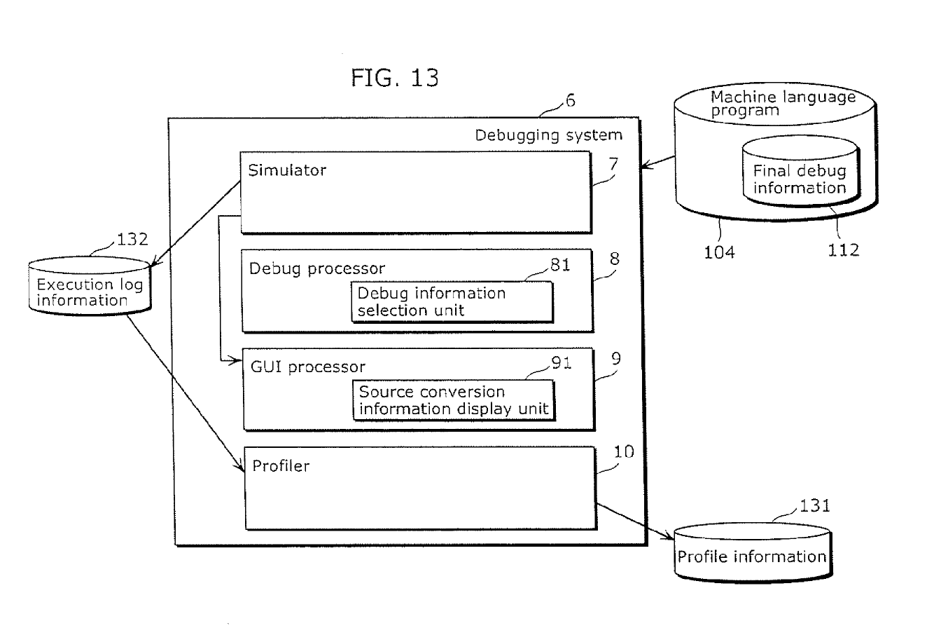

FIG. 13 is a block diagram showing a configuration of the debugging system 6 which is a constituent element of the program development system 11 according to the present invention.

The debugging system 6 is a development tool to support analysis/debugging of a program by receiving, as an input, the machine language program 104 generated in the compiling system 1 and performing simulation and information display of a program through an interactive interface with the user, and includes a simulator 7, a debug processor 8, a Graphical User Interface (GUI) processor 9, and a profiler 10.

The simulator 7 is an example of a program execution unit and an execution log output unit disclosed in the scope of claims. The debug processor 8 is an example of a debug support unit disclosed in the scope of claims. The GUI processor 9 is an example of a program display control unit disclosed in the scope of claims. The profiler 10 is an example of a profile information generation unit and a profiling unit disclosed in the scope of claims.

The simulator 7 has a function of analyzing a machine language instruction in the machine language program 104 and simulating the operation of the target processor. Furthermore, the simulator 7 has a function of outputting the execution log information 132 including a control flow and the number of cycles at the time of execution.

The debug processor 8 has a function of, with reference to the final debug information 112 in the machine language program 104, controlling simulation performed by the simulator 7 in accordance with the directive from the user, and performing a control so as to display necessary information by the GUI processor 9, and includes a debug information selection unit 81.

The debug information selection unit 81 selects, in accordance with an option designation by the user or a command directive, whether or not to provide a debugging function at the source level based on the original source program 101 or a debugging function at the source level based on the optimized source program 102. Specifically, the debug information selection unit 81 selects and refers to debug information based on the original source program 101 out of the final debug information 112 in the machine language program 104, in the case where “-orgsrc” option is designated is activated or “orgsrc” command directive is given when the debugging system 6 is activated, and provides a debug function based on the selected debug information. Furthermore, in the case where “-optsrc” option is designated or “optsrc” command directive is given, the debug information selection unit 81 selects and refers to debug information based on the optimized source program 102 out of the final debug information 112 in the machine language program 104, and provides a debug function based on the debug information.

For example, it is assumed that a file name of the machine language program 104 is “test.out” and a command for activating the debugging system 6 is “debug”. In this case, the user designates the “-orgsrc” option by inputting “debug -orgsrc test.out” on a command line.

The GUI processor 9 is a unit for providing a graphical user interface, has functions of receiving a designation from the user and displaying information relating to the program, and includes a source conversion information display unit 91. The source conversion information display unit 91 is an example of a conversion portion display control unit and a selection receiving unit disclosed in the scope of claims.

The source conversion information display unit 91 has a function of displaying information regarding the source portions before and after the optimization performed by the source level optimizer 3. Specifically, the source conversion information display unit 91, with reference to the final debug information 112, detects source portions in the original source program 101 and the optimized source program 102 corresponding to said portions or extracts information regarding said source portions from the optimized support information 123, and displays one or both of the source portions based on the directive from the user. Furthermore, the source conversion information display unit 91 is capable of displaying the number of execution cycles for each source portion and a selection status by the user. For the number of execution cycles, a valid value can be extracted from the final debug information 112 only in the case where the profile information 131, which is described later, is inputted to the compiling system 1.

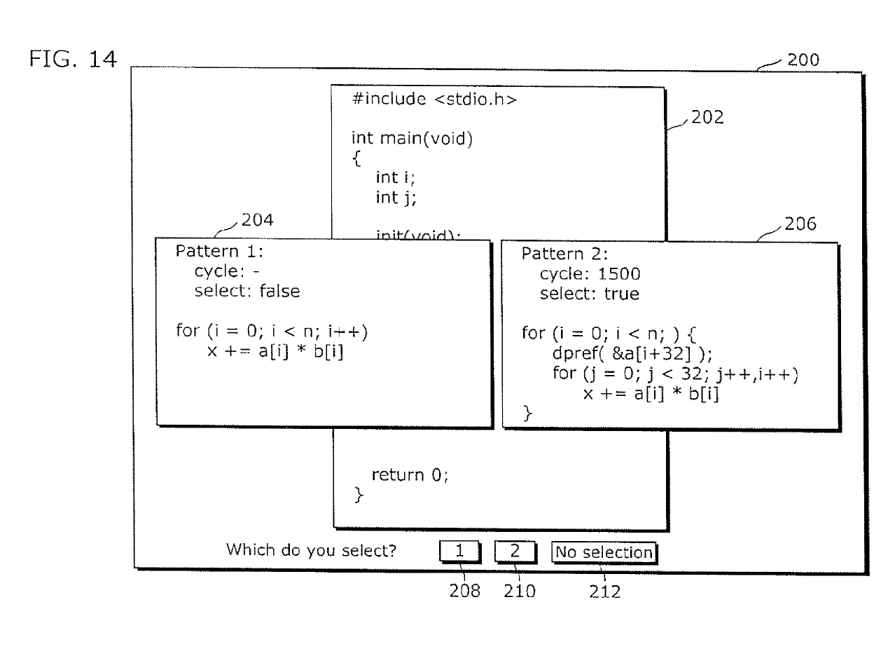

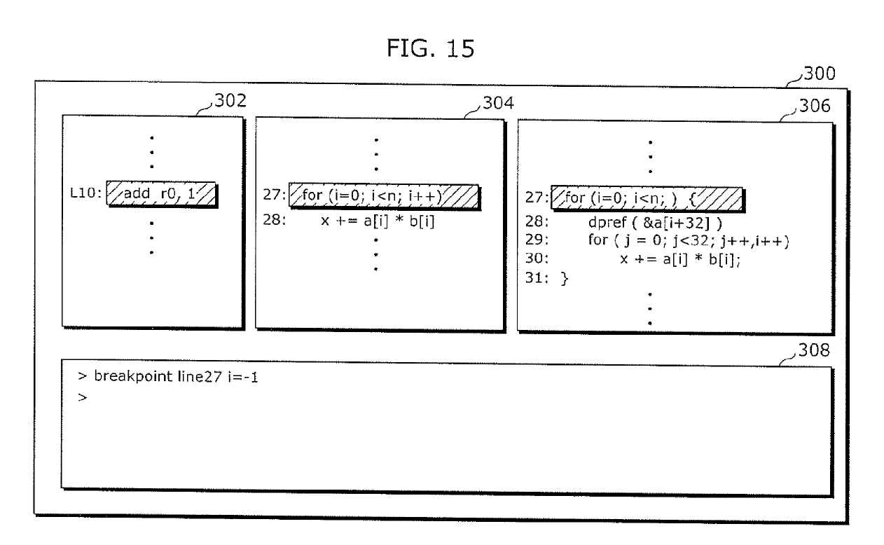

FIG. 14 is a diagram showing an example of source conversion information displayed on a display screen by the source conversion information display unit 91. The following is displayed on the display screen 200: a source program window 202; a pop-up window 204 for displaying a first conversion pattern; and a pop-up window 206 for displaying a second conversion pattern. The source program window 202 is a window for displaying the original source program 101. The pop-up window 204 is a window for displaying a portion of the original source program 101 before the conversion to be performed by the source level optimizer 3. The pop-up window 206 is a window for displaying a portion of the optimized source program 102 after the conversion performed by the source level optimizer 3 corresponding to the portion displayed on the pop-up window 204.

Note that, the programs before and after the conversion by the source level optimizer 3, which are respectively displayed on the pop-up window 204 and the pop-up window 206, indicate the number of execution cycles by which the program is executed and a conversion pattern selected by the user. Specifically, on the pop-up window 204, “cycle: -” and “select: false” are described, indicating that the number of execution cycles is undetermined and that this conversion pattern is not selected by the user. On the other hand, on the pop-up window 206, “cycle: 1500” and “select: true” are described, indicating that the number of execution cycles is 1500 cycles and that this conversion pattern is selected by the user.

By viewing these displays on the screen, the user can recognize a conversion candidate for the source level optimizer 3 as well as the number of execution cycles in some cases, and therefore the user can select one of the patterns to be preferred for a source program.

The user can designate which one of the conversion pattern candidates is to be selected, through the GUI processor 9, Specifically, a message “Which do you select?” indicating a user to select one of the two types of conversion patterns is displayed as well as three types of buttons 208 to 212 on the display screen 200. When the user presses the button 208 using a mouse or the like, a first conversion pattern displayed on the pop-up window 204 is selected, while when the user presses the button 210, a second conversion pattern displayed on the pop-up window 206 is selected. Furthermore, when the user presses the button 212, it indicates that the user does not select any one of the conversion patterns. Therefore, in the case where the user does not select one conversion pattern, the compiler 5 selects a conversion pattern with the minimum number of cycles so as to generate a machine language program 104.

The selection result of the conversion pattern is outputted to the profiler 10. The profiler 10 can output the user's selection as profile information 131 in the end. Note that the profile information 131 shall be later described in detail.

FIG. 15 shows a display screen showing results of debugging performed by the debug processor 8. The display screen is displayed by the GUI processor 9. The debug display screen 300 includes an assembler program display window 302, a pre-conversion source program display window 304, a post-conversion source program display window 306, and a command input/output window 308.

The original source program 101 is displayed on the pre-conversion source program display window 304. Note that, line numbers of the original source program 101 are simultaneously displayed.

The optimized source program 102 is displayed on the post-conversion source program display window 306. Note that, line numbers of the optimized source program 102 are simultaneously displayed.

The assembler program obtained as the result of compiling the optimized source program 102 is displayed on the assembler program display window 302. Note that, line numbers or labels of the assembler program are simultaneously displayed.

The command input/output window 308 is a window for displaying the debugging result obtained by the debug processor 8 and inputting a command for debugging.

The result obtained when a machine language program corresponding to an assembler program displayed on the assembler program display window 302 is executed by the simulator 7, is displayed on the debug display screen 300. For example, as displayed on the command input/output window 308, at the 27-th line of the original source program 1 01, an error is indicated because a value of a loop counter i, which originally has to be a positive number, is “−1”. Note that, error portions are displayed in highlight on the assembler program display window 302, the pre-conversion source program display window 204 and a post-conversion source program display window 306. The user can display error portions of the assembler program, original source program 101 and optimized source program 102 so as to be corresponding relationship with each other, by inputting an instruction to perform debugging on the command input/output window 308 or by substituting a value for each variable.

The profiler 10 analyzes the execution log information 132 received from the simulator 7, calculates the number of cycles to be performed by the source level optimizer 3 for each source conversion portion, sets the number of cycles so as to be associated with the source portion included in the final debug information 112, and outputs the profile information 131 which becomes a hint on optimization by the compiling system 1. Furthermore, in the case where the user selects one of the source conversion candidates through the GUI processor 9, the information regarding the selection is also outputted as the profile information 131.

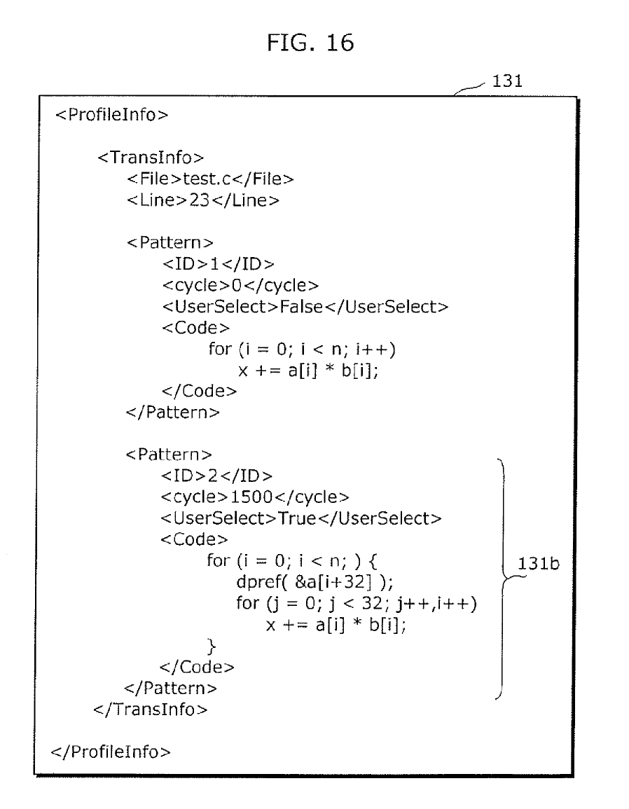

FIG. 16 is a diagram showing an example of the profile information 131 outputted by the profiler 10.

The profile information 131 corresponds to a portion enclosed in tags <ProfileInfo> and </ProfileInfo>. Note that, the portion enclosed in tags <TransInfo> and </TransInfo> indicates optimization support information which is support information for optimization performed at the time of compiling, The profile information 131 defines a value of the number of execution cycles based on the execution log analysis performed by the profiler 10 so that the value corresponds to each conversion pattern with respect to the optimization support information 123 in the source conversion debug information 111. Furthermore, it indicates a value showing a selection state which is one of “true” and “false” indicating whether or not the user has been selected a conversion pattern through the GUI processor 9. The optimization support information shown in FIG. 16 is the same as the optimization support information 123 shown in FIG. 9, and therefore its detailed explanation is not repeated here.

The profile information 131 is utilized by the profile information utilization optimization unit 33 included in the source level optimizer 3 in the compiling system 1.

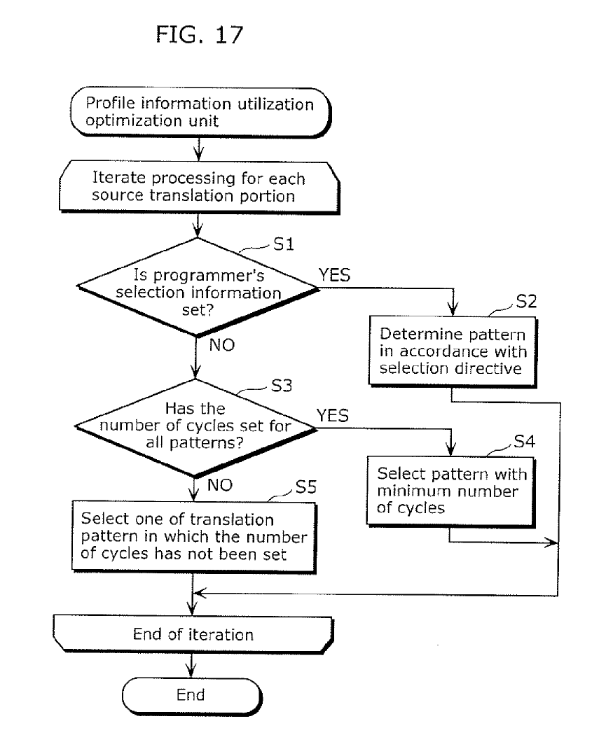

FIG. 17 is a flowchart showing processing details performed by the profile information utilization optimization unit 33.

The profile information utilization optimization unit 33, with 30 reference to the profile information 131, judges whether or not the information indicating that the user selects one of the candidate patterns has been set for each source conversion portion (which is the portion enclosed in tags <TransInfo> and </TransInfo>). Specifically, the profile information utilization optimization unit 33 judges whether or not there is a candidate pattern in which the portion enclosed in tags <UserSelect> and </UserSelect>indicates True.

In the case where it is set to select a candidate pattern (YES in S1), the profile information utilization optimization unit 33 determines a candidate pattern to be compiled, in accordance with a selection directive from the user (S2).

In the case where it is not set to select a candidate pattern (NO in S1), the profile information utilization optimization unit 33 judges, with respect to all the conversion candidates, whether or not the number of cycles has been set (S3). Specifically, the profile information utilization optimization unit 33 judges, for all the conversion candidates, whether or not a value other than “0” is set in the portion enclosed in tags <cycle> and </cycle>.

When judging that the number of cycles has been set for all of the conversion candidates (YES in 53), the profile information utilization optimization unit 33 selects a pattern with the minimum number of cycles out of the conversion candidate patterns as a candidate pattern to be compiled (S4).

In the case where there is a conversion candidate pattern in which the number of cycles has not been set (NO in S3), the profile information utilization optimization unit 33 arbitrary selects one of the conversion candidate patterns in which the number of cycles has not been determined, in order to cause the simulator 7 of the debugging system 6 to perform simulation for setting the number of cycles (S5). The selected conversion candidate pattern is a target to be compiled.

In the example shown in FIG. 16, the second conversion candidate pattern 131b is selected by the user. Accordingly, the conversion candidate pattern 131b is a target to be compiled.

According to the present embodiment, in the program development system 11, the machine language program 104 can be gradually updated by automatically activating the compiling system 1 and the debugging system 6 again and again through the machine language program 104 and the profile information 131. Specifically, a pattern with the minimum number of cycles can be automatically selected and determined with respect to multiple conversion candidates for source level conversion performed by the source level optimizer 3.

In the program development system 11, the user's time and efforts required for tuning are thus restrained at minimum and an optimum code can be generated.

Furthermore, even in the case where the source level optimizer 3 is adopted in the compiling system 1, the debug information (final debug information 112) can be generated based on the original source program 101. Therefore, the user can perform debugging at the source level based on the original source program 101. In addition, the amount of additional information such as the source conversion debug information 111 which does not exist in the conventional compiling systems can be reduced at best by utilizing as a combination of plural processes such as a line number retaining conversion process by the source level optimizer 3, a line adjustment process by the preprocessor 4 and the compiler 5, and the like.

Whereas the program development system according to the present invention and constituent elements thereof were described based on the above-identified embodiment, the present invention shall not be restricted to such embodiment. In other words, following modifications are assumed.

(1) Whereas a C language specification and a preprocessor directive specification are assumed in the above-identified embodiment, the present invention is not only restricted to the C language and thus remains significant even in the case of utilizing a different programming language.

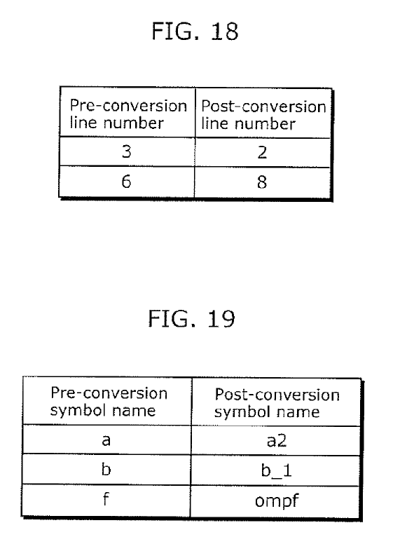

(2) Whereas a corresponding relationship between pre-conversion line numbers and post-conversion line numbers is indicated as a table structure as the line number table information 121, the present invention is not restricted to this information specification. For example, the present invention remains significant even in the case where a group of only the modified points of the line numbers (modified lines) is indicated. FIG. 18 is a diagram showing an example of line number table information which indicates a group of only the modified lines. The line number table information indicated in this diagram shows the same contents as indicated in the line number table information 121 shown in FIG. 7A. Specifically, it is indicated that the line starting from third line is of the original source program 101 which is the pre-conversion program corresponds to the line starting from second line of the optimized source program 102 which is the post-conversion program. It is also indicated that the line starting from sixth line of the original source program 101 corresponds to the line starting from eighth line of the optimized source program 102.

(3) Whereas a one-to-many corresponding relationship of modified symbols is indicated as a table structure as the symbol table information 122, the present invention is not restricted to this information specification. For example, the present invention maintains its significance even in the case where a table structure indicating a one-to-one corresponding relationship is used in accordance with a predetermined rule based on a debug specification such as adopting a final reference and the like when the pre-conversion symbol is divided into plural symbols. FIG. 19 is a diagram showing an example of the symbol table information indicated by the table structure for the one-to-one corresponding relationship. The symbol table information shown in FIG. 19 shows the same contents as the symbol table information 122 shown in FIG. 8. However, the symbol table information shown in FIG. 19 only indicates a symbol name which is lastly referred to, in the case where there are plural post-conversion symbol names. For example, a symbol name “b” of the original source program 101 is converted into symbol names of “b_{—}1”, “b_{—}2” and “b_{—}3” in the optimized source program 102. Here, since the last symbol name to be referred to out of the three symbol names is “b_{—}1”, the symbol table information shown in FIG. 19 describes the pre-conversion symbol name “b” in association with the post-conversion symbol name “b_{—}1”.

(4) Whereas in the present embodiment, the source conversion debug information 111 is outputted as a comment in the post-conversion source program (optimized source program 102) as shown in FIG. 9, the present invention is not restricted to this output method. For example, the present invention remains significant even in the case of adopting the specification of outputting the source conversion debug information 111 as a different file from the optimized source program 102.

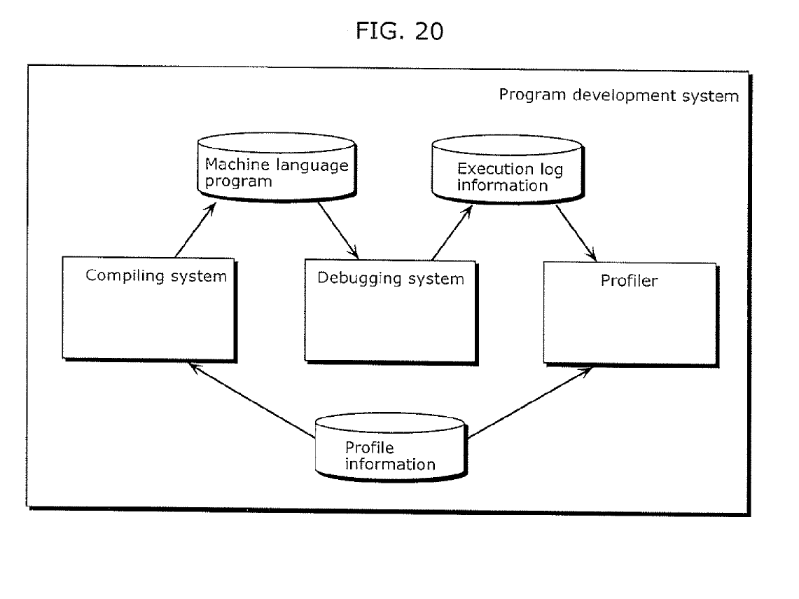

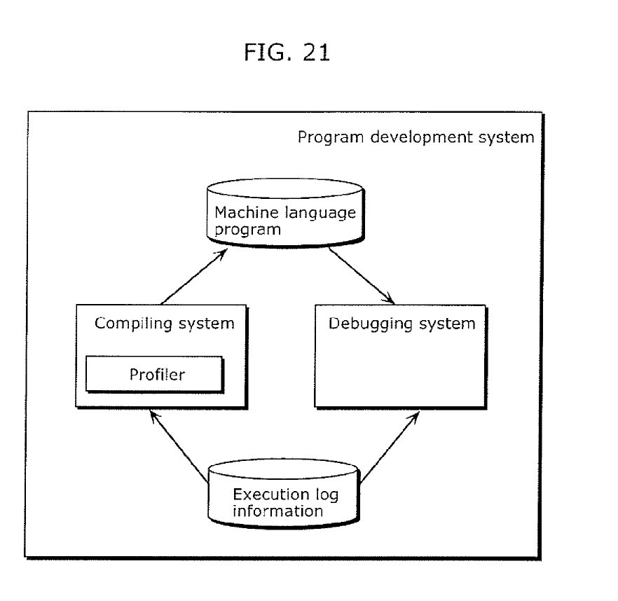

(5) Whereas in the present embodiment, the profiler 10, which outputs profile information for optimization in the compiling system 1, is placed in the debugging system 6, the present invention is not restricted to this configuration. For example, the effect of the present invention can be realized even in the case where the program development system is configured in that the profiler 10 is taken out as a profiler being an independent program as shown in FIG. 20 or that the profiler is placed inside the compiler as shown in FIG. 21.

(6) Whereas in the present embodiment, hint information to the compiling system 1 is given as the profile information 131, the present invention is not restricted to this directive method. For example, the present invention may adopt a method of providing hint information as a compile option as a type of a directive to the compiling system 1 by the user.

(7) Whereas in the present embodiment, the source conversion information display unit 91 of the debugging system 6 displays two pre-conversion and post-conversion source portions as shown in FIG. 14, the present invention is not restricted to this. The source portions are not restricted to two and therefore three or more source portions may be simultaneously or selectively displayed by transmitting the information relating to more than two conversion candidates via the debug information.

(8) Whereas in the present embodiment, the line adjustment unit 41 of the preprocessor 4 and the line number adjustment 51 of the compiler 5 recognize a pragma directive such as “#pragma” inserted by the source level optimizer 3, the present invention may adopt a configuration in which the directive for line adjustment is not restricted to the pragma directive and a specific build-in function is analyzed so as to recognize that the insertion of a built-in function is inserted by the source level optimizer.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is applicable to a program develop system and the like which includes a compiling system and a debugging system.

What is claimed is:

1. A compiling system for translating a source program into a machine language program, said system comprising:
a source program conversion unit operable to convert a first source program written in a high-level language into a second source program written in the high-level language, by optimizing the first source program at the source program level;
a compiling unit operable to convert the second source program into a machine language program; and
a debug information generation unit operable to generate first debug information which indicates a corresponding relationship between the first source program and the machine language program, by referring to a corresponding relationship between the first source program and the second source program and a corresponding relationship between the second source program and the machine language program.

2. The compiling system according to claim 1,
wherein said debug information generation unit is further operable to generate second debug information which indicates the corresponding relationship between the second source program and the machine language program.

3. The compiling system according to claim 2, further comprising
a debug information output unit operable to: receive one of directives; select one or both of the first debug information and the second debug information based on the received directive; and output the selected one or both of the first debug information and the second debug information in file format, the directives including a directive which instructs outputting only the first debug information in file format, a directive which instructs outputting only the second debug information in file format, and a directive which instructs outputting both the first debug information and the second debug information in file format.

4. The compiling system according to claim 1, further comprising:
a preprocessing unit operable to analyze a directive included in the second source program and to execute preprocessing on the second source program based on the result of the analysis; and
a directive deletion unit operable to delete, from the second source program, a line including the directive which is analyzed by said preprocessing unit and is added by said source program conversion unit.

5. The compiling system according to claim 4,
wherein the directive is a preprocessor directive or a build-in function.

6. The compiling system according to claim 1,
wherein said compiling unit includes
a line number information generation unit operable to: analyze a directive included in the second source program; execute processing on the second source program based on the result of the analysis; and generate line number information of the machine language program by deleting a line number of a line which includes a directive added by said source program conversion unit.

7. The compiling system according to claim 1,
wherein said source program conversion unit includes
a line number retaining conversion unit operable to convert the first source program into the second source program, while retaining a corresponding relationship between line numbers of the first source program and line numbers of the second source program.

8. The compiling system according to claim 7,
wherein said line number retaining conversion unit is operable to convert the first source program into the second source program by realigning plural statements in post-conversion statements included in the second source program into one line, in the case where the number of lines of post-conversion statements included in the second source program is greater than the number of lines of pre-conversion statements included in the first source program, so that the number of lines of pre-conversion statements is equal to the number of lines of the post-conversion statements.

9. The compiling system according to claim 7,
wherein said line number retaining conversion unit is operable to convert the first source program into the second source program by inserting a blank line into the post-conversion statements included in the second source program, in the case where the number of lines of the post-conversion statements included in the second source program is less than the number of lines of pre-conversion statements included in the first source program, so that the number of lines of the pre-conversion statements is equal to the number of lines of the post-conversion statements.

10. The compiling system according to claim 7,
wherein said source program conversion unit further includes
a source conversion debug information generation unit operable to generate source conversion debug information which collects modifications caused by the source program conversion performed by said line number retaining conversion unit.

11. The compiling system according to claim 10,
wherein the source conversion debug information includes information which indicates the corresponding relationship between the line numbers of the first source program and the line numbers of the second source program.

12. The compiling system according to claim 10,
wherein the source conversion debug information includes information which indicates the corresponding relationship between symbols included the first source program and symbols included in the second source program.

13. The compiling system according to claim 10,
wherein the source conversion debug information includes a statement which corresponds to a portion to be converted in the first source program, and a statement which corresponds to a portion in the second source program in which the portion to be converted has been converted.

14. The compiling system according to claim 10,
wherein said source conversion debug information generation unit is operable to insert, as a comment, the source conversion debug information into the second source program.

15. The compiling system according to claim 10,
wherein the first debug information includes the source conversion debug information.

16. A debugging system for supporting debugging of a machine language program, said system comprising:
a program execution unit operable to execute a machine language program which is obtained by compiling a second source program written in a high-level language, the second source program being obtained by optimizing a first source program written in the high-level language; and
a debug support unit operable to receive first debug information which indicates a corresponding relationship between the first source program and the machine language program and second debug information which indicates a corresponding relationship between the second source program and the machine language program, by referring to a corresponding relationship between the first source program and the second source program and the corresponding relationship between the second source program and the machine language program, and to support debugging of the machine language program by a user based on the first debug information, the second debug information, and the result of the execution obtained by said program execution unit.

17. The debugging system according to claim 16,
wherein said debug support unit is operable to receive one of a directive which instructs selecting the first debug information and a directive which instructs selecting the second debug information, and to support debugging of the machine language program by the user based on the result of the execution obtained by said program execution unit and one of the first debug information and the second debug information, in accordance with the received instruction.

18. The debugging system according to claim 17,
wherein the directive is one of a command directive and an optional directive which is given from outside when said debugging system is activated.

19. The debugging system according to claim 16, further comprising
a program display control unit operable to display the machine language program and one or both of the first source program and the second source program in correspondence with each other.

20. The debugging system according to claim 19,
wherein said program display control unit is operable to determine a program to be displayed, based on one of a command directive and an optional directive which is given from outside when said debugging system is activated.

21. The debugging system according to claim 16, further comprising:
a conversion portion display control unit operable to display a statement which corresponds to a portion to be converted in the first source program and a statement which corresponds to a portion in the second source program in which the portion to be converted has been optimized;
a selection receiving unit operable to receive a selection of one of the statement which corresponds to the portion to be converted and the statement which corresponds to the post-conversion portion; and
a profile information generation unit operable to generate, as profile information, information received by said selection receiving unit.

22. The debugging system according to claim 21,
wherein said profile information generation unit is operable to further add the number of execution cycles when the statement which corresponds to the portion to be converted or the statement which corresponds to the post-conversion portion is executed by said program execution unit.

23. A program development system for developing a machine language program from a source program, said program development system comprising:
a compiling system for converting a source program into a machine language program; and
a debugging system for supporting debugging of the machine language program,
wherein said compiling system includes:
a source program conversion unit operable to convert a first source program written in a high-level language into a second source program written in the high-level language, by optimizing the first source program at the source program level;
a compiling unit operable to convert the second source program into a machine language program; and
a debug information generation unit operable to generate first debug information which indicates a corresponding relationship between the first source program and the machine language program, by referring to a corresponding relationship between the first source program and the second source program and a corresponding relationship between the second source program and the machine language program, and
said debugging system includes:
a program execution unit operable to execute the machine language program which is obtained by compiling the second source program written in the high-level language, the second source program being obtained by optimizing the first source program written in the high-level language; and
a debug support unit operable to receive first debug information which indicates a corresponding relationship between the first source program and the machine language program and second debug information which indicates a corresponding relationship between the second source program and the machine language program, by referring to a corresponding relationship between the first source program and the second source program and the corresponding relationship between the second source program and the machine language program, and to support debugging of the machine language program by a user based on the first debug information, the second debug information, and the result of the execution obtained by said program execution unit,
said debugging system further includes
an execution log output unit operable to output an execution log obtained when said program execution unit executes the machine language program,
said program development system further comprises
a profiling unit operable to analyze the execution log outputted by said debugging system, and to output profile information which gives a hint on optimization in said compiling system, and
said source program conversion unit of said compiling system is operable to optimize the first source program based on the profile information.

24. A compiling method for translating a source program into a machine language program, said method comprising:
converting a first source program written in a high-level language into a second source program written in the high-level language, by optimizing the first source program at the source program level;
converting the second source program into a machine language program; and
generating first debug information which indicates a corresponding relationship between the first source program and the machine language program, by referring to a corresponding relationship between the first source program and the second source program and a corresponding relationship between the second source program and the machine language program.

25. A debug support method for supporting debugging of a machine language program, said method comprising:
executing a machine language program which is obtained by compiling a second source program written in a high-level language, the second source program being obtained by optimizing a first source program written in the high-level language; and
receiving first debug information which indicates a corresponding relationship between the first source program and the machine language program and second debug information which indicates a corresponding relationship between the second source program and the machine language program, by referring to a corresponding relationship between the first source program and the second source program and the corresponding relationship between the second source program and the machine language program, and supporting debugging of the machine language program by a user based on the first debug information, the second debug information, and the result of the execution obtained in said executing of the machine language program.

26. A program development method for developing a machine language program from a source program, said program development method comprising:
a compiling method; and
a debug support methods
wherein said compiling method is a compiling method for translating a source program into a machine language program, and includes:
converting a first source program written in a high-level language into a second source program written in the high-level language, by optimizing the first source program at the source program level;
converting the second source program into a machine language program; and
generating first debug information which indicates a corresponding relationship between the first source program and the machine language program, by referring to a corresponding relationship between the first source program and the second source program and a corresponding relationship between the second source program and the machine language program,
said debug support method is a debug support method for supporting debugging of the machine language program, and includes:
executing the machine language program which is obtained by compiling the second source program written in the high-level language, the second source program being obtained by optimizing the first source program written in the high-level language; and
receiving first debug information which indicates the corresponding relationship between the first source program and the machine language program and second debug information which indicates the corresponding relationship between the second source program and the machine language program, by referring to the corresponding relationship between the first source program and the second source program and the corresponding relationship between the second source program and the machine language program, and supporting debugging of the machine language program by a user based on the first debug information, the second debug information, and the result of the execution obtained in said executing of the machine language program,
said debug support method further includes
outputting an execution log obtained when the machine language program is executed,
said program development system further comprises
analyzing the execution log, and outputting profile information which gives a hint on optimization in said compiling method, and
in said converting of the first source program into the second source program in said compiling method, the first source program is optimized based on the profile information.

27. A program for translating a source program into a machine language program, said program causing a computer to execute:
converting a first source program written in a high-level language into a second source program written in the high-level language, by optimizing the first source program at the source program level;
converting the second source program into a machine language program; and
generating first debug information which indicates a corresponding relationship between the first source program and the machine language program, by referring to a corresponding relationship between the first source program and the second source program and a corresponding relationship between the second source program and the machine language program.

28. A program for supporting debugging of a machine language program, said program causing a computer to execute:
executing a machine language program which is obtained by compiling a second source program written in a high-level language, the second source program being obtained by optimizing a first source program written in the high-level language; and
receiving first debug information which indicates a corresponding relationship between the first source program and the machine language program and second debug information which indicates a corresponding relationship between the second source program and the machine language program, by referring to a corresponding relationship between the first source program and the second source program and the corresponding relationship between the second source program and the machine language program, and supporting debugging of the machine language program by a user based on the first debug information, the second debug information and the result of the execution obtained in said executing of the machine language program.

29. A development program for developing a source program from a machine language program, said development program causing a computer to execute:
a program for translating a source program into a machine language program; and
a program for supporting debugging of the machine language program,
wherein said program for translating the source program into the machine language program causes the computer to execute:
converting a first source program written in a high-level language into a second source program written in the high-level language, by optimizing the first source program at the source program level;
converting the second source program into the machine language program; and
generating first debug information which indicates a corresponding relationship between the first source program and the machine language program, by referring to a corresponding relationship between the first source program and the second source program and a corresponding relationship between the second source program and the machine language program,
said program for supporting debugging of the machine language program causes the computer to execute:
executing the machine language program which is obtained by compiling the second source program written in the high-level language, the second source program being obtained by optimizing the first source program written in the high-level language; and
receiving first debug information which indicates the corresponding relationship between the first source program and the machine language program and second debug information which indicates a corresponding relationship between the second source program and the machine language program, by referring to the corresponding relationship between the first source program and the second source program and the corresponding relationship between the second source program and the machine language program, and supporting debugging of the machine language program by a user based on the first debug information, the second debug information and the result of the execution obtained in said executing of the machine language program,
said program for supporting debugging of the machine language program further causes the computer to execute
outputting an execution log obtained when the machine language program is executed,
said development program further causes the computer to execute
analyzing the execution log, and outputting profile information which gives a hint on optimization for causing the computer to execute said program for translating the source program into the machine language program, and
in said converting of the first source program into the second source program executed by the computer in said program for translating the source program into the machine language program, the first source program is optimized based on the profile information.
